(19) United States
(12) Patent Application Publication
(10) Pub. No.: US 2016/0179178 A1
(43) Pub. Date: Jun. 23, 2016

(54) Energy-Saving Method

(71) Applicant: Elstat Limited, Preston (GB)

(72) Inventor: Philip Eric Lambert, Preston (GB)

(21) Appl. No.: 14/974,522

(22) Filed: Dec. 18, 2015

(30) Foreign Application Priority Data
Dec. 19, 2014 (GB) 1422709.4

(51) Int. Cl. G06F 1/32

(52) U.S. Cl. CPC G06F 1/3262; G06F 1/3287

(57) ABSTRACT

Disclosed is a method to enable a retail display or vending unit to switch to or from an energy saving mode. The method comprises listening for a radio frequency emitted by a mobile telephone and switching the unit from an energy saving mode when a radio frequency is detected and switching the unit to an energy saving mode when no radio frequency is detected. Also described is a retail display or vending unit comprising means to detect a radio frequency emitted from a mobile telephone and means to enable automatic switching off of components and/or processes and systems within the unit when low or no radio frequency is detected and to switch on components and/or processes and systems within the unit when radio frequency is detected.

### CROSS-REFERENCE TO RELATED APPLICATION

This application is related to and claims priority from U.K. Patent Application GB 1422709.4, filed Dec. 19, 2014, the entire contents of which are hereby fully incorporated herein by reference for all purposes.

The present invention encompasses a method for the detection of potential customers that informs a retail display or vending unit about the trading hours of its environment and thus when to turn to an energy-saving mode.

A retail display cabinet or unit (also encompassing a vending unit) generally comprises one or more storage compartments in which items may be stored and displayed for sale to customers. Typically, such a unit is used for storing and dispensing items at a point of sale, through a sales clerk or other store employee, as part of a retail display unit or as part of a point of sale display rack directly accessible by the customer. Alternatively, such units provide a self-service option to customers. The cabinets or units include display and storage of almost any type of product, generally presented to the consumer in a box, carton, wrapping, bag and the like, such as cigarettes, packaged foods, drinks, over the counter medicine, sweets, perfume, novelties, and the like.

Vending and display units are typically illuminated to attract the attention of potential customers. Vending and display units may also be refrigerated or heated to keep and provide saleable products at the correct temperature for immediate use or consumption. However, illumination and refrigeration consumes energy and, if the unit is illuminated and/or cooled 24 hours a day 375 days a year, the energy consumption is wasteful during periods of time when there is likely to be no customer activity, for example, when a retail outlet is closed for business.

There are a number of ways to reduce energy usage for vending and retail display units. For example, retail staff may switch off the electricity supply to the unit, or change settings on the unit so that illumination is dimmed and/or the unit is enabled to a different temperature. However, staff may forget. In addition, a refrigerated or heated unit takes time to reach the required temperature and so products are liable to be purchased at a sub-optimal temperature, thereby spoiling the retail experience for the customer.

The incorporation of clocks into vending and display units allows changes in modes of operation based on the opening and closing times of a store. However, manual input is often required if opening/closing times vary according to the day of the week, or change due to public holidays or if the store changes its business hours, or if the time changes seasonally.

More advanced units utilise motion sensors that detect the presence of a potential customer. The drawback with the use of such sensors is the first customer to be detected by the sensors may result in a lost sale because the unit is not (fully) illuminated and/or be at the correct temperature. In addition, such sensors are unidirectional and so a potential customer needs to be present directly in front of the sensor for presence to be detected.

U.S. Pat. No. 6,745,581 appreciates the drawbacks of motion sensors and describes a system that enables a vending unit to learn usage and/or activity patterns which then inform the unit when to activate and turn off or change its illumination and/or refrigeration/heating system. The unit bases its behaviour on historical data gathered from a human presence detector, such as a motion detector, an infrared sensor or a vibration detector, typically over the course of the previous seven days. While such a system obviates the need for manual input, it is not able cater for varying hours of operation within a week, for example to cater for a public holiday on one day. The system also retains the significant drawback of requiring interaction with the unit, whether it be removing product from the unit or simply standing in front of a vending unit.

The present invention seeks to overcome the problems associated with existing methods of detecting the presence of a potential customer in a way that requires no interaction with a vending or retail display unit.

### BRIEF DESCRIPTION OF THE DRAWING

The present invention will now be described in detail by way of example as illustrated in the accompanying FIGURE in which:

FIG. 1 is a trace representing detection of 900 MHz and 1800 MHz mobile phone radio frequency signals in the vicinity of an antenna in which the X axis is time in one minute intervals and the Y axis is the power detected at the two frequencies (expressed as analogue to digital steps (0.04V)).

### DESCRIPTION

In its broadest aspect, the present invention enables a vending or retail display unit to switch automatically to or from an energy saving mode based on human presence or absence.

In particular, the present invention resides in a method to enable a retail display or vending unit to switch to or from an energy saving mode, wherein the method comprises listening for a radio frequency emitted by a mobile telephone and switching the unit from an energy saving mode when a radio frequency is detected and switching the unit to an energy saving mode when no radio frequency is detected.

Since over 90% of people carry a mobile telephone about their person, either in a pocket or in a bag, the physical presence of a person is easily detected without the person needing to be close to the vending or retail display unit. Instead, the vending or retail display unit listens for a radio frequency that is routinely emitted by a mobile telephone, whether the telephone is switched on and in normal operation or on standby.

In this way, the retail display or vending unit is able to switch to or from an energy saving mode depending on detection of the radio frequency. For example, if the unit has been in a hibernation, energy saving mode overnight while a store is closed for business, the presence of the retail owner in the store first thing in the morning will be sufficient to alert the unit and set it into a mode where the unit is fully illuminated and, if refrigerated or heated, set to the appropriate temperature for vending. The presence of a person via the mobile telephone carried by the person also obviates the need for the person to take an interest in the unit and/or its contents or to approach or walk directly in front of the unit.

Another advantage of the invention is that the location of the person is not critical for operation of the unit. While motion and vibration detectors and infrared sensors are unidirectional, hardware typically used for the reception of mobile telephone radio frequencies is omnidirectional. In this way, the present invention enables the retail display or vending unit to be independent of physical human interest or close proximity.

The method also includes maintaining the retail display or vending unit in an operational mode while a radio frequency emitted from a mobile telephone is detected. An operational mode is one where the unit is fully functional for vending, is illuminated where necessary and refrigerated or heated to a correct vending temperature, where appropriate.

It will be appreciated that reference to a mobile telephone encompasses any machine to machine (M2M) device that uses mobile telephone technology and generates radio frequency (RF) disturbances when switched on and in normal operation (standby or active use).

Preferably, switching from an energy saving mode results in illumination of the unit, to attract the attention of potential customers and indicate that the unit is ready to vend.

In some cases, retail display or vending units are refrigerated or heated to provide customers with products at the ideal temperature. This is particularly important for perishable and consumable goods such as chilled drinks or hot food. Accordingly, switching from an energy saving mode alternatively or additionally activates a refrigeration or heating system associated with the unit respectively to cool or warm the unit to an operational preset temperature.

As an example, an operational preset temperature may be between −5 and 8 degrees Centigrade for frozen and chilled beverages and food, or above 63 degrees Centigrade for cooked or reheated food that needs to be kept hot.

It will be appreciated that an operational preset temperature is a temperature at which products displayed or stored in the unit are presented to customers for immediate consumption and/or optimal product longevity.

While cooling and heating are specifically mentioned above, a unit may also be used for storing, selling and/or displaying goods that require a degree of humidity, such as cigars and medicines.

Ideally, switching to an energy saving mode results in reduced or no illumination of the unit. In this way, the unit uses less energy when there are no potential customers in the vicinity and also indicates to potential customers that the unit is not ready to vend.

Where a retail display or vending unit is refrigerated or heated, it is preferred that a refrigeration or heating system associated with the unit is switched to a preset temperature that is respectively warmer or cooler that an operational preset temperature when the unit switches to an energy saving mode.

For example, the unit may be instructed to run its associated refrigeration system to cool the unit to between 8 and 10 degrees Centigrade when the operational preset temperature is, say, 5 degrees Centigrade.

Mobile telephones emit radio waves typically at a frequency of between about 700 MHz and 1 GHz (preferably between about 806 MHz and 960 MHz) or between about 1.7 GHz to 2.5 GHz (preferably between about 1.71 GHz and 2.03 GHz), depending on the country. Thus, it is advantageous if detection is selected for either or both of these ranges of frequencies and, in any event, for a range of frequencies that is appropriate for the country of location.

To assist with clarity of detection, in one embodiment the radio frequency is detected above a threshold level. In this way, the mobile telephones of people passing in a street outside a store in which the unit is located are less likely to be detected and provide the unit with false instructions, whereas the presence of people in the store is detected. For example, the threshold for detection of the radio frequency may be set according to power of the frequency to be detected or by the sensitivity of the detection means. In this way, a single mobile telephone may not be detected but more than a certain number will be. Alternatively, a mobile telephone signal that is weakly detected may be ignored for being out of a desired catchment area for the unit. The sensitivity of detection may be altered and tailored according to the location of a unit.

It will be appreciated that it is desirable if the threshold is variable and selectable on a unit to enable detection to be tailored for a specific location of a unit and according to its surroundings. For example, a unit may be sited close to a lot of passing human traffic either when a store is closed for business or on a busy high street. Increasing or decreasing the threshold value has the same effect as increasing or reducing the range of the devices captured in a catchment area.

Alternatively or in addition, the power detection threshold may be changed at set times of the day to reduce the likelihood of detecting radio frequencies while a store is closed for business.

The threshold may further include a limitation on vertical detection. Expressed in another way, the field of detection may be limited in its vertical field to reduce the likelihood of detecting radio frequencies from a floor above the unit. Thus, radio frequencies may be detected in a circular (or part thereof) band around a unit.

To increase the clarity of detection further and reduce the likelihood of false instruction to a unit, it is preferred if background radio frequencies are substantially filtered out.

The method may further include filtering the radio frequency. One example is to measuring the duration of the frequency. In this way, small bursts of radio waves emitted by apparatus such as fluorescent light bulbs may be ignored.

The method may yet further include a delay on the switch to the energy-saving mode so that the switch is activated after a preset period of time after the last detection of a mobile telephone. The inclusion of such a delay ensures the unit remains fully operational while there are quiet periods in trading around the unit and to preclude switching between modes in between detection of radio frequencies.

It will be appreciated that radio frequencies may be detected by any means known to the skilled person. However, a preferred method is by way of an antenna, particularly an omnidirectional antenna.

While the present invention has been described by way of a method, it will be appreciated that the invention also encompasses a retail display or vending unit comprising means to detect a radio frequency emitted from a mobile phone and means to enable automatic switching the unit to an energy saving mode when low or no mobile telephone radio frequency is detected and to switch the unit from an energy saving mode when a mobile telephone radio frequency is detected. This enables the unit to reduce its energy consumption when there is low or no human presence in the vicinity of the unit.

In one embodiment, the means to detect a radio frequency emitted from a mobile phone may be an antenna. Preferably, the antenna is able to work in a frequency range from about 50 MHz to about 3.0 GHz and is tuned to a desired frequency to capture radio frequency emitted within a range. For example, the antenna may be tuned to 883 MHz to monitor a frequency range from about 806 MHz to about 960 MHz.

Ideally, the means to enable automatic switching on and off of components and/or processes and systems within the unit may be a microprocessor connected to the means to detect a radio frequency, wherein the microprocessor is programmed to change one or more preset functions within the unit according to the detection or not of a radio frequency emitted from a mobile telephone.

The one or more present functions may be selected from the group comprising: illumination (on or off), level of illumination (high or low illumination), temperature (operational temperature or energy-saving temperature).

Alternatively or in addition, the means to detect a radio frequency emitted from a mobile telephone may be set to detect a radio frequency above a threshold. Expressed in another way the means may include one or more filters that limits the sensitivity and/or area of detection. Preferably, the threshold, and thus the sensitivity of the detection means, is adjustable. Ideally, the threshold may be adjustable to enable the field of detection to be tailored to the location of the unit. An example of a threshold is power of the radio frequency emitted by a mobile telephone.

The detection means may also include a frequency filter to filter out background noise and/or radio frequencies emitted by other devices. For example, the filter may be based on the duration of the radio frequency so the detector ignores pulses emitted by a fluorescent light when it is turned on.

The unit may further include a time delay before automatically switching the unit to an energy-saving mode when low or no mobile telephone radio frequency is detected.

A 16 cm antenna and a 33 cm antenna detected radio frequencies emitted at 1800 Mhz and 900 Hz respectively from mobile telephones in an office environment that included a refrigerated beverage merchandise unit.

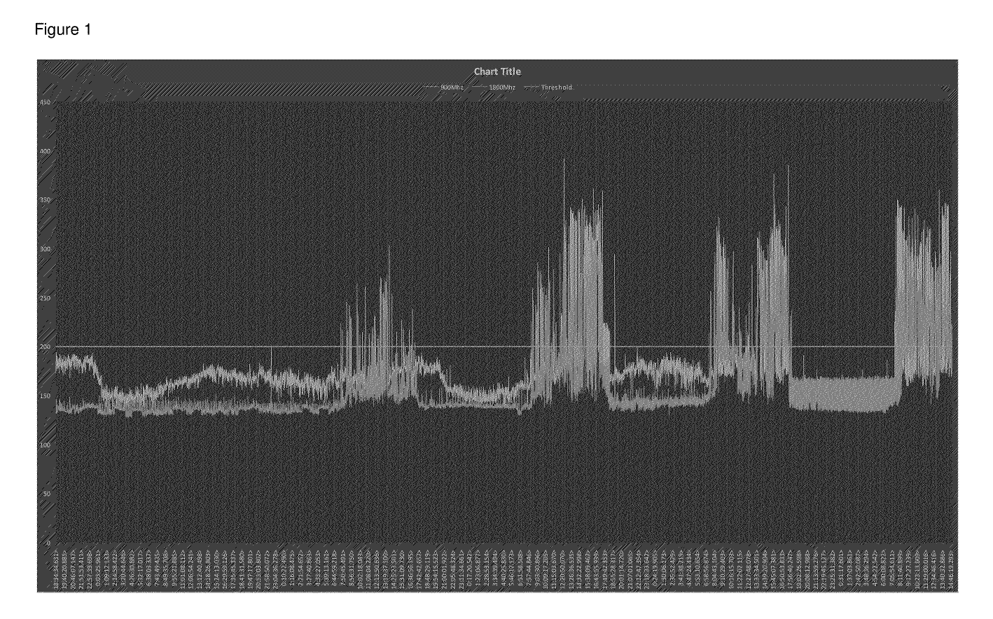

As shown in FIG. 1, mobile telephones were detected on Day One during the hours of 07:33 and 17:21, on Day Two between 08:26 and 19:08 and on Day Three between 07:26 and 17:55.

The line indicated at the value of 200 on the y axis is a suggested threshold. The value is derived from an analogue-to-digital converter on a microcontroller having a 10 bit input at 5V. Thus the 200 value represents 0.97V. Any radio frequency detected under the threshold value is treated as background noise which the refrigerated beverage merchandise unit is instructed to ignore. Any mobile telephone device that is sufficiently close to the unit to register an analogue-to-digital value above 200 will be registered by the unit which is then instructed to switch from a stand-by, energy-mode to a fully operation mode or to maintain the unit in its fully operational mode.

1. A method to enable a retail display or vending unit to switch to or from an energy saving mode wherein the method comprises listening for a radio frequency emitted by a mobile telephone and switching the unit from an energy saving mode when a radio frequency is detected and switching the unit to an energy saving mode when no radio frequency is detected.

2. The method of claim 1, wherein switching from an energy saving mode results in illumination of the unit.

3. The method of claim 1, wherein switching from an energy saving mode activates a refrigeration or heating system associated with the unit respectively to cool or warm the unit to an operational preset temperature.

4. The method of claim 1, wherein switching to an energy saving mode results in reduced or low illumination of the unit.

5. The method of claim 1, wherein switching to an energy saving mode activates a refrigeration or heating system associated with the unit respectively to cool or warm the unit to a preset temperature that is respectively warmer or cooler that an operational preset temperature.

6. The method of claim 1, wherein the radio frequency is between about 700 MHz and 1 GHz and/or between about 1.7 GHz and 2.5 GHz.

7. The method of claim 1, wherein the method further includes a threshold for detection of the radio frequency.

8. The method of claim 1, wherein the radio frequency is detected above a threshold level of power.

9. The method of claim 1, wherein the method further includes filtering background radio frequencies.

10. The method of claim 1, wherein the radio frequency is detected by an antenna.

11. A retail display or vending unit comprising means to detect a radio frequency emitted from a mobile telephone and means to enable automatic switching of the unit to an energy-saving mode when low or no radio frequency is detected and automatic switching the unit from an energy saving mode when a radio frequency is detected.

12. The unit of claim 11, wherein the means to detect a radio frequency emitted from a mobile phone is an antenna.

13. The unit of claim 12, wherein the antenna is tuned to a frequency to detect radio frequencies in a range of from about 50 MHz to about 3.0 GHz.

14. The unit of claim 12, wherein the antenna is tuned to a frequency of about 883 MHz.

15. The unit of claim 13, wherein the antenna is tuned to a frequency of about 883 MHz.

16. The unit of claim 11, wherein the means to enable automatic switching to and from an energy saving mode is a microprocessor connected to the means to detect a radio frequency, wherein the microprocessor is programmed to change one or more preset functions within the unit according to the detection or not of a radio frequency emitted from a mobile telephone.

17. The unit of claim 16, wherein the one or more present functions is selected from the group comprising: illumination, level of illumination, temperature.

18. The unit of claim 11, wherein the means to detect a radio frequency emitted from a mobile telephone is set to detect a radio frequency above a predetermined threshold.

19. The unit of claim 18, wherein the predetermined threshold is power of the radio frequency.

20. The unit of claim 18, wherein the predetermined threshold is adjustable.

21. The unit of claim 19, wherein the predetermined threshold is adjustable.
